(19) United States
(12) Patent Application Publication
(10) Pub. No.: US 2008/0310059 A1
(43) Pub. Date: Dec. 18, 2008

(54) ESD PROTECTION DESIGN METHOD AND RELATED CIRCUIT THEREOF

(76) Inventors: Te-Chang Wu, Hsinchu City (TW); Yu-Ming Sun, Taoyuan County (TW); Chien-Kuo Wang, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 11/762,057

(22) Filed: Jun. 12, 2007

(51) Int. Cl. G06F 17/50; H02H 9/00

(52) U.S. Cl. 361/56; 716/10

(57) ABSTRACT

The invention discloses a method for electrostatic discharge (ESD) protection design. The method includes: placing a first input/output cell (I/O cell) and a second input/output cell at a side of a chip, wherein a routing area exists at the side of the chip and is positioned between the first input/output cell and the second input/output cell; providing an electrostatic discharge protection circuit unit; and placing the electrostatic discharge protection circuit unit in the routing area.

### BACKGROUND OF THE INVENTION

1. Field of the Invention

The present invention relates to a circuit layout method and related circuit, and more particularly, to an electrostatic discharge protection design method capable of placing electrostatic discharge protection circuit according to the area between two existing adjacent input/output cells and/or the area between an input/output cell and a corner cell, and related circuit thereof.

2. Description of the Prior Art

Since the complementary metal-oxide semiconductor (CMOS) production technology has advanced well into the submicron and nanometer scale, integrated circuit (IC) performance has risen correspondingly. Nowadays, many integrated circuits are guided into mass production by the CMOS process. Some advanced process technologies within integrated circuits such as thinner gate-oxide, shallower drain/source, and metal silicide, can effectively increase the integration and improve the characteristics of the devices. However, these advanced process technologies also significantly decrease the electrostatic discharge (ESD) robustness of the integrated circuit. Therefore, the ESD is more likely to become a bottleneck in the mass production yield rate of integrated circuits.

Please refer to FIG. 1. FIG. 1 illustrates a circuit layout diagram of a prior art chip 100. The chip 100 comprises a plurality of input/output cells (I/O cells) 110 for receiving an input signal or sending an output signal; a plurality of routing areas 120 each disposed between two input/output cells 110; and a plurality of corner cells 130. Generally speaking, each input/output cell 110 within the chip 100 is connected to a pad, and the plurality of routing areas 120 is utilized as connections between power/ground routings of each input/output cell 110. That is, the prior art routing areas 120 are utilized to provide electrical connection paths for the power line and/or the ground line.

The input/output cells 110 allow the chip 100 to connect external circuits/chips to realize the entire function of the system level. However, when the chip 100 is undergoing packaging, testing, transporting, processing and assembling, the input/output cells 110 can easily come in contact with undesired external electrostatic sources. Thus, unwanted electrostatic power is transmitted to the internals of chip 100 and can result in damage of the internal circuitry; this is the so-called ESD event. Therefore, the typical input/output cell 110 has an ESD protection circuit (not shown) implemented therein. An ESD protection circuit serves as a conductive path with low impedance between two input/output cells 110, so that induced ESD currents will pass through this path instead of through other internal circuits in the chip 100. In this way, the internal circuits of the chip 100 are protected from being damaged by ESD events. Equivalently, when the ESD event occurs, the ESD circuit is activated to effectively short the input/output cells 110, and to guide any ESD currents into the bypass path instead of into the internal circuits of the chip 100. During the regular operation of the chip 100, however, the ESD circuit turns the low-impedance current path off between two input/output cells to avoid interfering with the regular operation of the chip 100.

Generally speaking, many ESD protection circuits are configured into the circuit design to improve the performance of ESD protection. However, increasing these ESD protection circuits leads to a larger layout area and thus a higher cost of the chip. Therefore, choosing proper ESD protection circuits and proper circuit layout is an important topic in circuit layout design.

### SUMMARY OF THE INVENTION

It is an objective of the claimed invention to provide an electrostatic discharge protection design method capable of placing an electrostatic discharge protection circuit unit according to a area between two existing input/output cells, and related circuit thereof.

According to one embodiment of the claimed invention, an electrostatic discharge protection design method is disclosed. The method comprises: placing a first input/output cell (I/O cell) and a second input/output cell at a side of a chip, wherein a routing area exists on the side and is positioned between the first input/output circuit unit and the second input/output circuit unit; providing an electrostatic discharge protection circuit unit; and placing the electrostatic discharge protection circuit unit to the routing area.

According to one embodiment of the claimed invention, a chip with an electrostatic discharge protection function is further disclosed. The chip comprises: a first input/output cell (I/O cell) positioned at a side of a chip; a second input/output cell positioned at the side of the chip, wherein a routing area exists at the side and is positioned between the first input/output cell and the second input/output cell; and an electrostatic discharge protection circuit unit positioned in the routing area.

According to one embodiment of the claimed invention, an electrostatic discharge protection design method is further disclosed. The method comprises: arranging an input/output circuit unit (I/O cell) and a corner cell at a side of a chip, wherein a routing area exists at the side and is positioned between the input/output cell and the corner cell; providing an electrostatic discharge protection circuit unit; and placing the electrostatic discharge protection circuit unit to the routing area.

According to one embodiment of the claimed invention, a chip with an electrostatic discharge protection function is further disclosed. The chip comprises: an input/output cell (I/O cell) positioned at a side of the chip; a corner cell positioned at the side of the chip, wherein a routing area exists at the side and is positioned between the input/output cell and the corner cell; and an electrostatic discharge protection circuit unit positioned in the routing area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a circuit layout diagram of a prior art chip.

FIG. 2 illustrates a circuit layout diagram of a chip according to one embodiment of the present invention.

FIG. 3 is a circuit diagram for placing a power clamp circuit in a routing area between two input/output cells according to one embodiment of the present invention.

FIG. 4 is a circuit diagram illustrating a first embodiment of the power clamp circuit shown in FIG. 3.

FIG. 5 is a circuit diagram illustrating a second embodiment of the power clamp circuit shown in FIG. 3.

FIG. 6 is a circuit diagram illustrating a third embodiment of the power clamp circuit shown in FIG. 3.

FIG. 7 illustrates a circuit diagram for placing a capacitor in a routing area between two input/output cells according to one embodiment of the present invention.

FIG. 8 is a flowchart of an electrostatic discharge protection design method according to one embodiment of the present invention.

### DETAILED DESCRIPTION

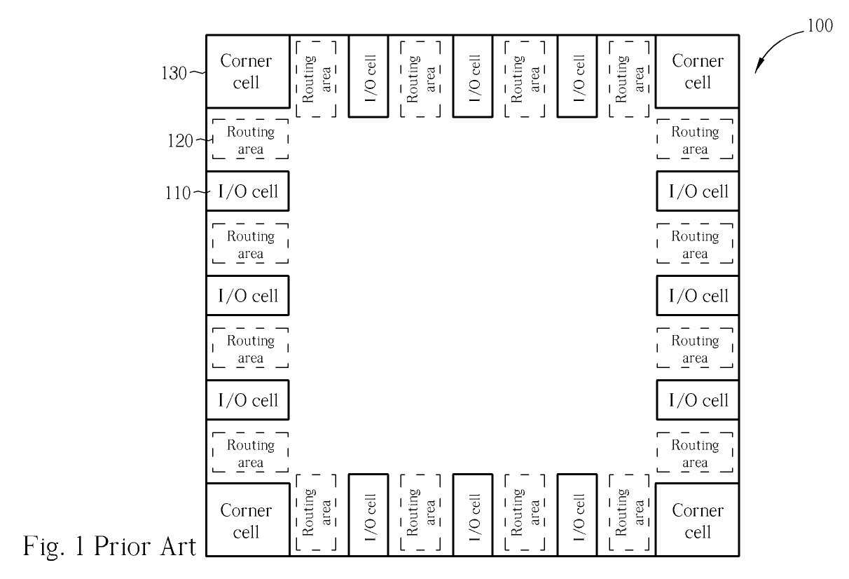

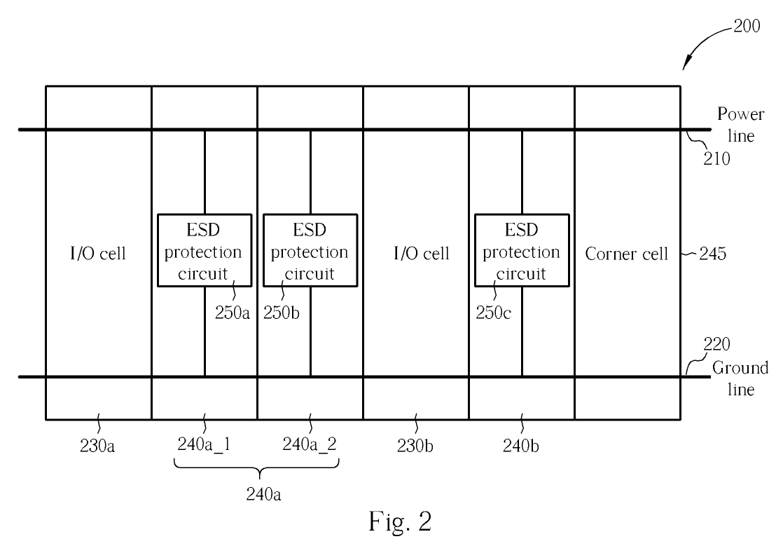

Please refer to FIG. 2. FIG. 2 illustrates a circuit layout diagram of a chip 200 according to one embodiment of the present invention. As shown in FIG. 2, a power line 210, a ground line 220, a plurality of input/output cells 230a and 230b for receiving an input signal or sending an output signal, a plurality of routing areas 240a and 240b in a space between two input/output cells 230a and 230b and in a space between the input/output cell 230b and a corner cell 245, respectively, and a plurality of electrostatic discharge (ESD) protection circuits 250a, 250b and 250c are positioned at a side of the chip 200. Compared with the prior art chip 100 in FIG. 1, FIG. 2 only shows part of the chip 200. In this embodiment, the routing areas 240a and 240b not only provide connections to the power line 210 and the ground line 220, but also place the ESD protection circuits 250a, 250b and 250c between the power line 210 and the ground line 220 to provide ESD protection. Additionally, in the embodiment shown in FIG. 2, the size of the routing area 240a is greater than the size of the routing area 240b. Therefore, more ESD protection circuits 250a and 250b are placed respectively in two sub-routing areas 240a_1 and 240a_2 of the routing area 240a. Please note that the plurality of ESD protection circuits 250a, 250b and 250c can be individually implemented by different type of the ESD protection circuits according to design requirements. In other words, the circuit layout method disclosed by the present invention can determine the type and the number of the ESD protection circuits to be used according to the size of the routing area.

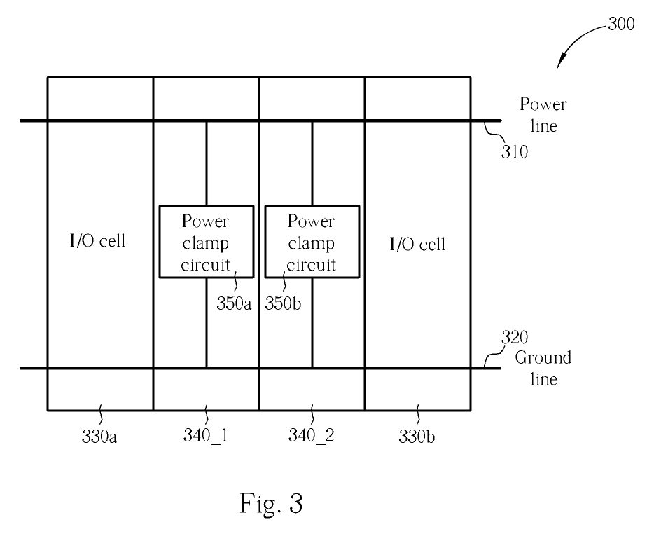

Please refer to FIG. 3. FIG. 3 illustrates a circuit diagram for placing a power clamp circuit in a routing area between two input/output cells according to one embodiment of the present invention. As shown in FIG. 3, a power line 310, a ground line 320, a plurality of input/output cells 330a and 330b for receiving an input signal or/and sending an output signal, a routing area 340 between two input/output cells, and a plurality of power clamp circuits 350a and 350b respectively placed in sub-routing areas 340_1 and 340_2 of the routing area 340 are positioned at a side of a chip 300. The routing area 340 not only provides connections to the power line 210 of the input/output cells 330a and 330b, but also places the plurality of ESD protection circuits 350a and 350b between the power line 310 and the ground line 320 to provide the ESD protection function. In this embodiment, provided the routing area 340 is larger, more power clamp circuits 350 can be placed in the same routing area 340 to achieve better ESD protection. This is only an embodiment, however, and is not meant to be a limitation of the present invention. Please note that the power clamp circuits 350a and 350b can be individually implemented by different types of the ESD protection circuits according to design requirements. Generally speaking, the input/output cells 330a and 330b set at the side of the chip 300 are also utilized for placing the ESD protection circuits according to layout arrangements and design requirements. Additionally, this embodiment only illustrates placing the power clamp circuit in the routing area between two input/output cells; however, according to the above-mentioned method, a skilled person can readily appreciate that the power clamp circuit can also be placed in the routing area between the input/output cell and the corner cell. Further description is omitted here for brevity.

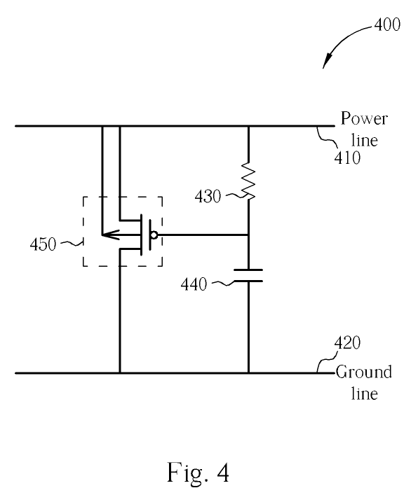

Please refer to FIG. 4. FIG. 4 is a circuit diagram illustrating a first embodiment of the power clamp circuit shown in FIG. 3. As shown in FIG. 4, a power clamp circuit 400 is connected between a power wire 410 and a ground wire 420. The power clamp circuit 400 comprises a resistor 430, a capacitor 440, and a p-type metal-oxide semiconductor (PMOS) transistor 450. In practice, the capacitor 440 can be implemented by a metal-oxide semiconductor capacitor (MOS capacitor), and the capacitor 440 and resistor 430 form a resistor-capacitor network (RC network). In this embodiment, when an electrostatic waveform occurs at power line 410, because of the signal delay effect due to the RC network, the rising rate of the voltage at node V1 is slower than the rising rate of the voltage at the power line 410. Therefore a voltage difference occurs between node V1 and the power line 410. At the same time, the same voltage difference occurs between the PMOS transistor 450 and the power line 410. When this voltage difference is greater than the threshold voltage of the PMOS transistor 450, the PMOS transistor 450 is turned on and the PMOS becomes conductive. Therefore the ESD protection circuit (i.e., the power clamp circuit 400) can provide an ESD current path to avoid damages due to the current flowing into the internal circuits of an integrated circuit when the ESD event occurs.

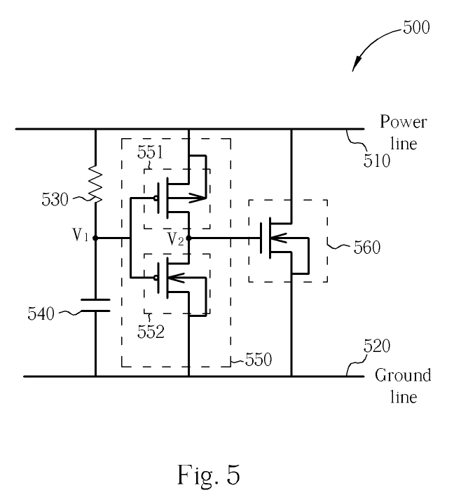

Please refer to FIG. 5. FIG. 5 a circuit diagram illustrating a second embodiment of the power clamp circuit shown in FIG. 3. As shown in FIG. 5, a power clamp circuit 500 is connected between a power line 510 and a ground line 520, and comprises a resistor 530, a capacitor 540, an inverter 550, and an n-type metal-oxide semiconductor (NMOS) transistor 560. In practice, the capacitor 540 can be implemented by a metal-oxide semiconductor capacitor (MOS capacitor), and the resistor 530 and the capacitor 540 form a resistor-capacitor network (RC network). The inverter 550 comprises a PMOS transistor 551 and an NMOS transistor 552. In this embodiment, when an electrostatic waveform occurs at the power line 510, because of the signal delay effect due to the RC network, the rising rate of the voltage at node V1 is slower than the rising rate of the voltage at the power line 510, and the same voltage difference occurs between the PMOS transistor 551 and the power line 510. When this voltage difference is greater than the threshold voltage of the PMOS transistor 551, the PMOS transistor 551 is turned on and be comes conductive, and the voltage at node V2 is pulled up to a level close to the voltage level of the power line 510. Regarding the NMOS transistor 560, the node V2 is the gate and the voltage at node V2 is greater than the threshold voltage of the NMOS 560. Then, the NMOS 560 is turned on to be conductive for discharging the induced electrostatic current. Therefore, the ESD protection circuit (i.e., the power clamp circuit 500) can provide an ESD current path to avoid damage from to electrostatic currents flowing into the internal circuits of the integrated circuit when the ESD event occurs.

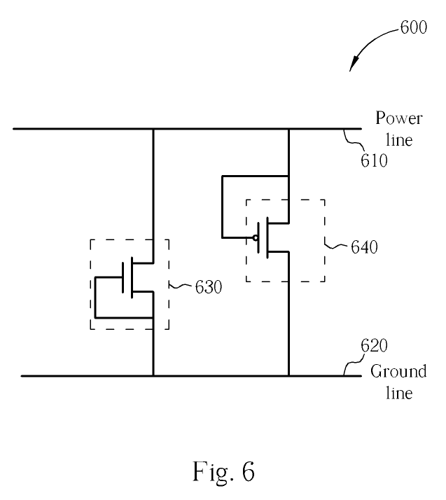

Generally speaking, implementing more ESD protection circuits will lead to better ESD protection performance. If there is insufficient space between two input/output cells or between the input/output cell and a corner cell, however, the present invention further discloses a power clamp circuit with a smaller layout area. As shown in FIG. 6, FIG. 6 illustrates a circuit diagram illustrating a third embodiment of the power clamp circuit shown in FIG. 3. A power clamp circuit 600 is connected between a power line 610 and a ground line 620, and comprises an NMOS transistor 630 and a PMOS transistor 640. Therefore, the power clamp circuit 600 has a smaller layout area. In this embodiment, the NMOS transistor 630 and the PMOS transistor 640 can separately serve as the power clamp circuit to discharge electrostatic current.

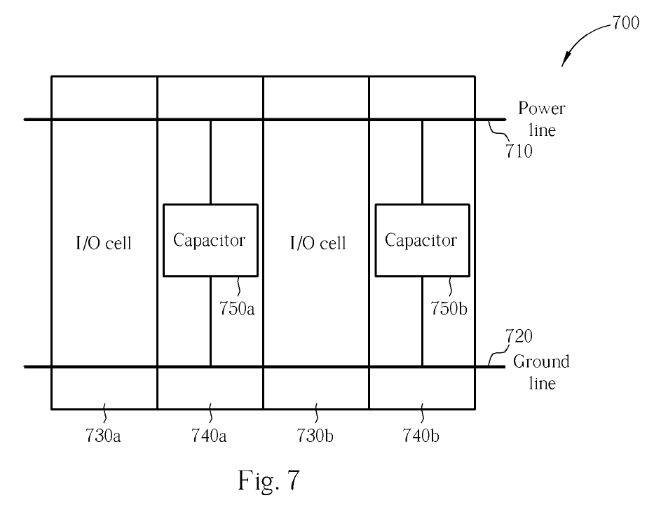

The power clamp circuit is utilized as the aforementioned ESD protection circuit placed in the routing area between two input/output cells. However, it is not intended to limit the scope of the present invention. Please refer to FIG. 7. FIG. 7 illustrates a circuit diagram for placing a capacitor in a routing area between two input/output cells according to one embodiment of the present invention. As shown in FIG. 7, a power line 710, a ground line 720, a plurality of input/output cells 730a and 730b for receiving the input signal or/and sending the output signal, a plurality of routing areas 740a and 740b between two input/output cells, and a plurality of capacitors 750a and 750b respectively placed in the routing areas 740a and 740b are positioned at a side of a chip 700. The routing areas 740a and 740b not only provide connections to the power/ground lines of the input/output cells, but also place the capacitors 750a and 750b between the power line 710 and the ground line 720 to provide ESD protection. In this embodiment, if the routing areas 740a and 740b are smaller, the entire circuit of the above-mentioned power clamp circuit cannot be placed in the routing areas 740a and 740b. To remedy the insufficient space, the capacitors 750a and 750b can be placed in routing areas 740a and 740b to serve as capacitors of the RC network implemented in the aforementioned power clamp circuit, and the other components of the power clamp circuit can be placed in the input/output cells 730a and 730b, indirectly improving the ESD protection capability of the chip 700. Additionally, this embodiment only illustrates placing the capacitor in the routing area between two input/output cells. However, according to the above-mentioned method, a skilled person can readily appreciate that the capacitor can also be placed in the routing area between the input/output cell and the corner cell.

Please note that, in the embodiment shown in FIG. 3, each routing area has a power clamp circuit placed therein; and in the embodiment shown in FIG. 7, each routing area has a capacitor placed therein. However, this is for illustrative purposes only. That is, in other embodiments of the present invention, a plurality of routing areas of a chip can simultaneously have power clamp circuits, capacitors and/or other ESD protection devices respectively placed therein according to design requirements.

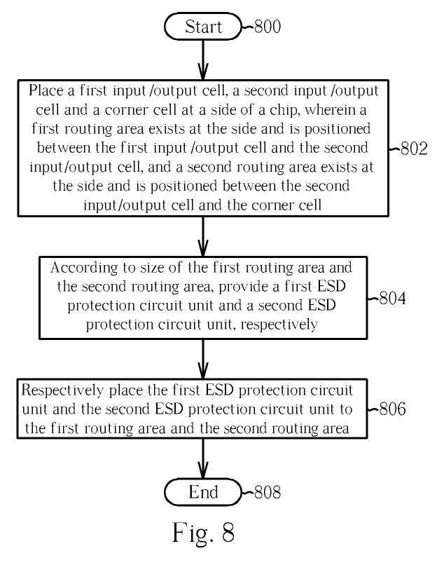

Please refer to FIG. 8. FIG. 8 is a flowchart of an ESD protection design method according to one embodiment of the present invention. The ESD protection design method is used to realize the circuit layout of the chip 200 shown in FIG. 2. The steps are summarized as below:

Step 800: Start;

Step 802: Place a first input/output cell (e.g., the input/output cell 230a shown in FIG. 2), a second input/output cell (e.g., the input/output cell 230b shown in FIG. 2) and a corner cell (e.g., the corner cell 245 shown in FIG. 2) at a side of a chip, wherein a first routing area (e.g., the routing area 240a shown in FIG. 2) exists at the side and is positioned between the first input/output cell and the second input/output cell, and a second routing area (e.g., the routing area 240b shown in FIG. 2) exists at the side and is positioned between the second input/output cell and the corner cell;

Step 804: According to size of the first routing area and the second routing area, provide a first ESD protection circuit unit and a second ESD protection circuit unit (e.g., power clamp circuits, capacitors and other ESD protection devices), respectively.

Step 806: Respectively place the first ESD protection circuit unit and the second ESD protection circuit unit to the first routing area and the second routing area; and

Step 808: End.

Please note that, because the technical features of the ESD protection design of the present invention are disclosed in above paragraphs, the detailed operations of each step of the flow in FIG. 8 are not repeated here for the sake of brevity.

Those skilled in the art will readily observe that numerous modifications and alterations of the device and method may be made while retaining the teachings of the invention.

What is claimed is:

1. An electrostatic discharge protection design method, comprising:
placing a first input/output cell (I/O cell) and a second input/output cell at a side of a chip, wherein a routing area exists at the side and is positioned between the first input/output cell and the second input/output cell;
providing an electrostatic discharge protection circuit unit; and
placing the electrostatic discharge protection circuit unit in the routing area.

2. The method of claim 1, wherein the step of providing the electrostatic discharge protection circuit unit comprises:
choosing at least one of candidate electrostatic discharge protection circuits as the electrostatic discharge protection circuit according to a size of the routing area.

3. The method of claim 1, wherein the electrostatic discharge protection circuit is a capacitor.

4. The method of claim 1, wherein the electrostatic discharge protection circuit is a power clamp circuit.

5. A chip with an electrostatic discharge protection function, comprising:
a first input/output cell (I/O cell), positioned at a side of the chip;
a second input/output cell, positioned at the side of the chip, wherein a routing area exists at the side and is positioned between the first input/output cell and the second input/output cell; and
an electrostatic discharge protection circuit unit, positioned in the routing area.

6. The chip of claim 5, wherein the electrostatic discharge protection circuit unit is a capacitor.

7. The chip of claim 5, wherein the electrostatic discharge protection circuit unit is a power clamp circuit.

8. An electrostatic discharge protection design method, comprising:
placing an input/output circuit unit (I/O cell) and a corner cell at a side of a chip, wherein a routing area exists at the side and is positioned between the input/output cell and the corner cell;
providing an electrostatic discharge protection circuit unit; and
placing the electrostatic discharge protection circuit unit in the routing area.

9. The method of claim 8, wherein the step of providing the electrostatic discharge protection circuit unit comprises:
choosing at least one of candidate electrostatic discharge protection circuits as the electrostatic discharge protection circuit according to a size of the routing area.

10. The method of claim 8, wherein the electrostatic discharge protection circuit is a capacitor.

11. The method of claim 8, wherein the electrostatic discharge protection circuit is a power clamp circuit.

12. A chip with an electrostatic discharge protection function, comprising:
an input/output cell (I/O cell), positioned at a side of the chip;
a corner cell, positioned at the side of the chip, wherein a routing area exists at the side and is positioned between the input/output cell and the corner cell; and
an electrostatic discharge protection circuit unit, positioned in the routing area.

13. The chip of claim 12, wherein the electrostatic discharge protection circuit unit is a capacitor.

14. The chip of claim 12, wherein the electrostatic discharge protection circuit unit is a power clamp circuit.
